(19) United States
(12) Patent Application Publication
(10) Pub. No.: US 2009/0143125 A1
(43) Pub. Date: Jun. 4, 2009

(54) POPULATION OF LANDMARKS FOR USE WITH A MAP APPLICATION

(75) Inventors: Patrick M. Baudisch, Seattle, WA (US); John C. Krumm, Redmond, WA (US); Daniel John Liebling, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/947,443

(22) Filed: Nov. 29, 2007

(51) Int. Cl. A63F 13/00; G06F 19/00

(52) U.S. Cl. 463/9; 463/43

(57) ABSTRACT

An interactive map-based game is provided for populating a landmark database with commonly known landmarks. A game session can provide a user with a number of maps that can be presented in succession. Each map presented can be a map segment that is a function of a latitude/longitude pair and a zoom level. A user can enter the names of landmarks believed to be contained in the map segment. If the name entered matches a name within a landmark database, points can be awarded. Once a threshold level of positive confirmations of a landmark name are received, the landmark can be marked as taboo and further entries of that landmark name can be disregarded or minimal points can be awarded for the entry.

### BACKGROUND

Mapping systems that provide direction information and location of various registered locales are commonly utilized. Map making has largely been carried out by visitors to a particular place. The knowledge of places acquired by these visitors was then aggregated and assimilated. The person with the best available knowledge of a particular area was in a superior position when it came to conquest, settlement, or trade. As the world was discovered, knowledge of its geography gradually spread to more and more people and maps improved. As technology advanced, so did the accuracy of mapmaking until arriving at what today is generally agreed upon as maps of the world.

Many location-based applications, such as yellow pages or social mobile applications use maps to communicate location to users. In contrast, maps cannot be used as part of text-based or voice-based communication, such as a Short Message Service (SMS), on a phone, or while driving. Textual addresses, can be slow to perceive due to their lengths, require significant cognitive effort, and may fail if the user requesting the information is unfamiliar with the area.

When people communicate locations to each other, they often base their descriptions on mutually known landmarks. For example, people can agree to meet in a certain place or can discuss having spent the first night of their backpacking trip at “the hotel in Agra, Northern India, a mile north of the Taj Mahal”.

In contrast, computer programs communicate location using more formal, canonical presentations. Global Positioning Systems (GPS) typically express location as pairs of latitude and longitude. Car navigation systems use a lookup table to translate the latitude/longitude pair into street addresses. Thus, instead of suggesting meeting at a particular place, such as in front of the Ritz Carlton, a navigation system will refer to “2801 Main St., City, State”. The Indian location may turn into “XX Street, India”. Unfortunately, these formal representations are often not the best way of communicating a location. First, parsing a formal address tends to take time and effort. Secondly, the communication may fail entirely if the person receiving the location information does not know the city and streets involved in the address.

Understanding a formal address requires users at the receiving end to parse the address into their own reference system. In some situations, that reference system can be a system of landmarks. Communicating a notation using the receiver's landmarks can speed up the process by bypassing this conversion. For example stating, “The conference center is located at the corner of Main Street and Third Street” typically requires more processing than “two blocks north of the conference hotel”. This is also useful for navigation tasks that involve spatial relationships between the involved locations, such as the decision whether to walk or take a taxicab.

The situation where the receiver does not know the cities and streets is generally the case for unfamiliar or foreign cities. For cities with which the receiver is familiar, in many ways, cities and streets are just particular, commonly agreed on sets of landmarks. While the grid layout (e.g., plus mnemonic street names, such as 5th Ave., and the use of the first two digits of a street address to indicate the cross street) used by many United States cities can make it easier to locate an address. However, street navigation in Europe and many other parts of the world requires substantial local street knowledge and therefore it can fail more often.

### SUMMARY

The following presents a simplified summary in order to provide a basic understanding of some aspects of the disclosed examples. This summary is not an extensive overview and is intended to neither identify key or critical elements nor delineate the scope of such aspects. Its purpose is to present some concepts in a simplified form as a prelude to the more detailed description that is presented later.

In accordance with one or more examples and corresponding disclosure thereof, various aspects are described in connection with populating a landmark database with landmarks that can be utilized with a mapping application. An interactive game can be provided as an incentive for a multitude of users to interact with a map area and provide landmark information. Users can receive points for entering landmarks contained in provided map segments. Based on input information, a known landmark can be confirmed and/or multiple names can be associated with the landmark.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the various aspects may be employed. Other advantages and novel features will become apparent from the following detailed description when considered in conjunction with the drawings and the disclosed examples are intended to include all such aspects and their equivalents.

### BRIEF DESCRIPTION OF THE DRAWINGS

FIG. 1 illustrates a system for populating a map application with landmark information that can be utilized by a multitude of users to obtain directions for a target location based on a landmark description.

FIG. 2 illustrates a displayed map segment.

FIG. 3 illustrates a screen shot of an interactive landmark game.

FIG. 4 illustrates a system for providing an interactive location based game.

FIG. 5 illustrates another system for providing an interactive landmark game.

FIG. 6 illustrates a method for providing an interactive map based landmark game.

FIG. 7 illustrates a method for awarding points as a function of a spatial coordinate and/or zoom level.

FIG. 8 illustrates a block diagram of a computer operable to execute the disclosed embodiments.

FIG. 9 illustrates a schematic block diagram of an exemplary computing environment operable to execute the disclosed embodiments.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Various aspects will be presented in terms of systems that may include a number of components, modules, and the like. It is to be understood and appreciated that the various systems may include additional components, modules and/or may not include all of the components and/or modules discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

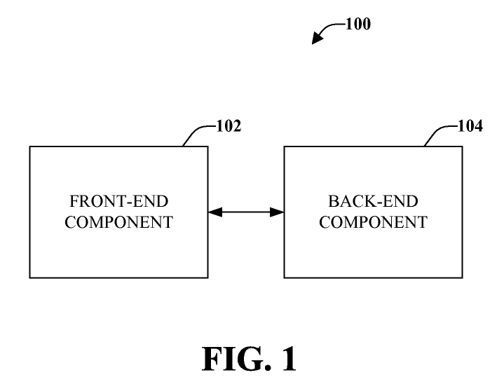

Referring initially to FIG. 1, illustrated is a system 100 for populating a map application with landmark information that can be utilized by a multitude of users to obtain directions for a target location based on a landmark description(s). In order to provide directions there should be to be a sense of location, which can be something that is not a direction. One manner of describing how to arrive at a particular location is to provide guidance by utilizing a number of different locations that can be described using landmarks. Many landmarks can become a subset of a direction while also maintaining individually as a landmark. Thus, a conversation can include the statement, “Let's meet at the Space Needle.” This statement does not imply where each participant is located or how each participant will travel to the Space Needle. In many cases, the location or directions to the landmark are not needed, depending on each participant's familiarity with the area. In another example, a real estate agent might have three different properties and explain the area where each property is located by reference to a landmark. The real estate agent might say a first house is near the Space Needle, a second house is off Route 5, and a third house is on Lake Washington. Without any notion of how to get to the houses, a prospective buyer might have a sense of where each house is located and a preferred location. Thus, having a sense of where something is located and a sense of the neighborhood can be functions of a similar concept.

In further detail, system 100 includes a front-end component 102 that can be configured to present, in a perceivable manner, information relating to a map area. The map area can be presented to a user and/or entity (e.g., the Internet, another system, a computer and so forth), hereinafter referred to as user. Front-end component 102 can be a Web page that displays a map area to a user. The user can interact with the front-end component 102 to enter landmarks with which the user is familiar. To facilitate entry of such landmarks, front-end component 102 can present the map segment or area and associated information in an interactive game format, wherein a user is awarded “points” for each accurate landmark entered. The interactive game can be played by a single user.

To facilitate matching a user entry with known landmarks, a back-end component 104 can be configured to retain information relating to known landmarks, possible landmarks, a user-recognizable name for a landmark, and other landmark information. Names entered by users can be compared to known landmarks and such known landmarks and associated names can be confirmed. For example, if multiple users enter the same landmark name, there is a higher confidence level that the landmark is known by a majority of users by that name, which might be an alternate name for the landmark (e.g., slang or unofficial name). New landmarks can include landmark names and locations input by users of the game, but which were not previously known by system 100. A user-recognizable name for a landmark is a name that is different from the “official” name of the landmark and might refer to the name that most people associate with the landmark.

Back-end component 104 can also be configured to maintain information relating a user, such as entered landmarks, maps viewed (including area and zoom level), as well as other user information. The user information can relate to a current game session or a previous game session. The information retained and processed by back-end component 104 is transparent to the user, thus the user simply interacts with the front-end component 102 and does not have to be aware of the processing and other functions performed by back-end component 104.

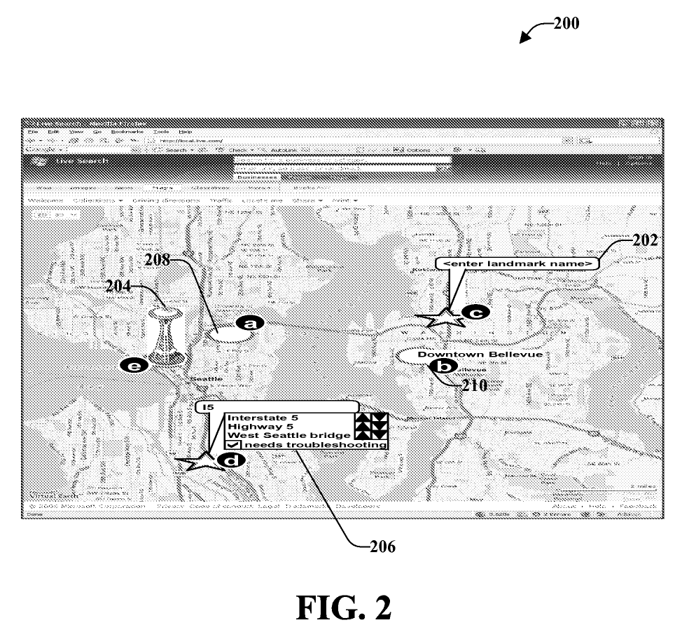

Front-end component 102 can display a segment of a map, such as the exemplary map 200, illustrated in FIG. 2. The user can add landmarks by selecting or clicking a location and entering a text label into a text box 202. In accordance with some aspects, system 200 can offer n icons at the edge of the screen, each icon depicting a different type of landmark (a sight, a bar, a street, a lake, and so forth). However, offering a predetermined number of n icons might result in the user choosing only landmarks from the given set. Thus, a hybrid approach of combining icons and free text can be utilized to allow a user to match an icon with a location or type in landmarks known by the user.

Users can create a location of the landmark by dragging the respective icon to a desired location, illustrated at 204. In accordance with some aspects, a pop-up menu or other menu can be utilized to create the icons. These icons can provide extra input that can be utilized to allow users to provide better descriptions for others that might view the map whose knowledge areas are known (e.g., exclude all bars). Icons can also give the map a more attractive appearance and can provide the users a feeling of creating the world. In accordance with some aspects, in order to avoid up-front bias, the icon, if provided, can be placed after a free text description. This positioning can provide the opportunity for the user to enter information about the landmark before perceiving the icon.

If a landmark with the same name in roughly the same area is found or matched, that landmark's counter is incremented and the user can continue entering more landmarks. The matching of the landmark can be based on information relating to the landmarks that are pre-populated in a database based on known information (e.g., official names and locations of prominent landmarks). The matching can also be based on input from other users that were received previously (e.g., a slang name or a name by which the landmark is more commonly called). Thus, system 100 can compare user inputs against an existing database of landmark, previous entries from users, or combinations thereof. If no exact match is found, the system 100 can ask for help to merge the newly entered landmark with earlier entries that might have been provided by other users under a different landmark name.

System 100 can automatically display a menu with closely collocated and/or similar sounding landmark names, as illustrated at 206. If users identified one of the entries as being a synonym to the landmark entered, the user can select or click one of the two arrow buttons adjacent or near the landmark. The up arrow indicates, “the existing name is better”, and it can overwrite the user's text with the existing (e.g., known) landmark name. The down arrow can indicate, “my description is better” and system 100 retains the user's landmark name and adds a comment to the database that it might be a better name for the existing landmark name. System 100 can store multiple names for a single landmark and can utilize the resulting thesaurus to pre-select disambiguation dialogs in the future (e.g., when a subsequent player enters landmark information). A generic “needs troubleshooting” checkbox at the bottom (or positioned elsewhere) allows users to flag cases that might need manual cleanup from a human operator or might need further review.

The same or a similar map can be presented to different users. Before presenting the map to a user, all landmarks are removed, except maxed out landmarks, which will be described below. However, in accordance with some aspects, the maxed out landmarks are displayed. The more often a landmark is entered, identified, or named by different users, the more confident the system becomes that this entry is reliable. When a landmark's counter passes a certain threshold level, it is considered confirmed (e.g., confidence that the landmark exists and is known by a particular name, which might be different from an “official” name). After meeting or exceeding the threshold level, the landmark is assigned a familiarity value:

familiarity=f(#LandmarkEntriesInMap, #LandmarksMaxedOutBefore, #usersWorkedOnThisMap)

Since all three parameters increase monotonically, the first landmark that maxes out is assigned the highest familiarity on the map and all subsequent ones are assigned lower familiarity values.

Once a landmark has maxed out it, is permanently added to the map segment and is possibly visible to all subsequent users working with this map segment. However, in accordance with some aspects, the landmark might not be visible to subsequent users. The landmark can also be made “taboo”, which means users cannot enter that landmark information. This helps direct user effort to where it is needed, rather than repeating what has already been confirmed.

FIG. 2 illustrates taboo landmarks at 208 and 210, which can be marked with circles or by another means of blanking out the landmark. Users can inspect the labels of taboo landmarks by hovering a mouse or other pointing device over the location, illustrated at 210. The labels might not be shown all the time to limit clutter on the display area. However, in accordance with some aspects, the labels can be shown. Taboo landmark markers are given a certain extent. The area covered by taboo labels cannot be clicked, which prevents users from entering other landmarks in the immediate vicinity of an existing landmark. These collocated landmarks would be less likely to be used in descriptions, so system 100 attempts to avoid such landmarks. Additional landmarks in the periphery of a taboo landmark can be entered later if the respective segment is rerun in a zoomed in version; here the taboo are can cover less real estate, due to the smaller scale of the map. In accordance with some aspects, other users can enter other landmarks in the vicinity of an existing landmarks.

A map segment can be closed off (e.g., do not present it to anymore users if no more high-familiarity landmarks are to be expected), as low familiarity landmarks are unlikely to be used in a description with respect to a target location. System 100 can detect that a map segment is ready to be closed off if the three values in the familiarity formula (described above) have reached values so high that the familiarity value to be assigned to the next landmark to max out will be below a threshold. This is the case if LandmarksMaxedOutBefore is high, meaning that there are already many landmarks in this map segment. This indicates that this map segment is well covered. This can also be the case if users move on to a new map by either pressing “done” or by clicking “unfamiliar map, I pass”. The latter leaves the map segment without incrementing the #usersWorkedOnThisMap counter. Clicking the former, however, increments the counter suggesting that there are no more good landmarks remaining to be identified. If #LandmarkEntriesInMap is high, it indicates there are many landmarks mentioned only once or twice (e.g., that there is no convergence between users). Landmarks that users disagree about might not be beneficial. Given the nature of the familiarity formula, any combination of these three parameters can cause a map to be closed off and not available for subsequent users.

To cover larger parts of a map, the map can be covered one segment at a time. To create good landmarks fast, a zoomed-out view can be presented illustrating the entire space of interest. When this space is closed off (or earlier if users want to continue to play), the next lower zoom level is tackled by the users.

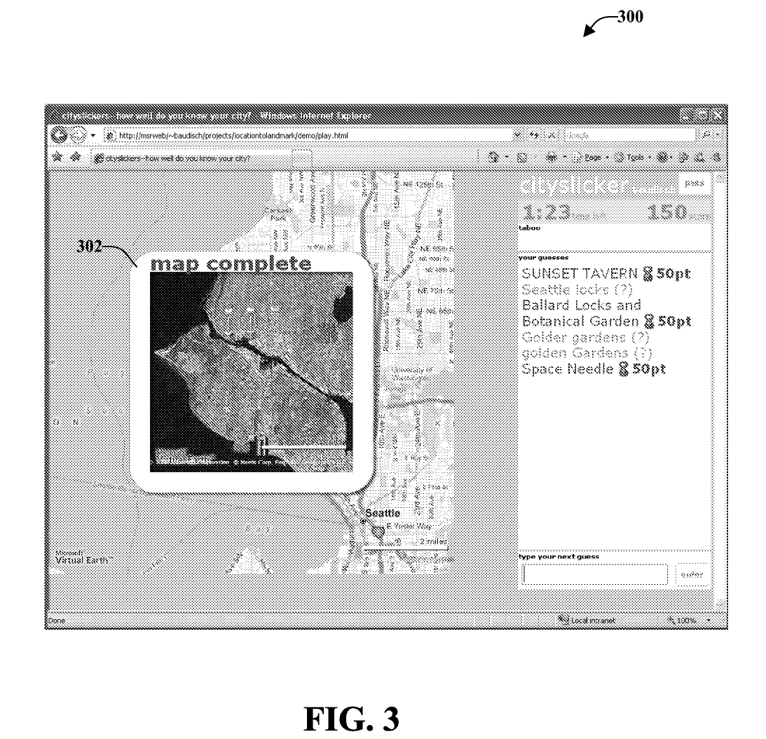

Across runs or different games, map segments are kept unchanged (e.g., the maps show the same rectangle at the same resolution). This assures that each landmark receives the same chance of maxing out. Still, landmarks at the very edge might be at a disadvantage, as they can be more difficult to view and are somewhat less in the user's focus of attention. As illustrated in the exemplary interactive game 300 of FIG. 3, this can be addressed by covering up a certain border around the edge with a semitransparent border 302, behind which the map is visible, but cannot be selected. In addition, map segments can be provided with a few pixels of overlap to make sure each landmark can be selected easily in at least one of the maps.

The described algorithm can be low on overhead and for a single city, such as Seattle, the map can be populated with useful landmarks with a small number of users, such as 20 users, for example. In order to cover large areas, such as the country or the entire world, more users than an immediate social network could offer would be beneficial to label more landmarks. To attract additional people to create data (e.g., landmark location), a point schema can be defined that provides feedback to “players” to pick top performers and to reward the top performers, such as in a game format.

Exemplary rules of the game can include, by default that a user receives one point for each landmark entered. This can be a user's basic incentive to play the game. If the landmark can be matched with previously entered landmarks, the user can receive as many points as the new count of the landmark. This can offer an incentive to choose popular landmarks. If the landmark could be matched with an existing database (e.g., known landmarks, landmarks entered by other users) without the disambiguation dialog, the score is doubled. This can provide an incentive for the user to concentrate about what other people might call the landmark and to spell the name carefully. The score obtained from the first n landmarks entered (such as 3, for example) is multiplied by {3, 2, 1.5}. This can provide an incentive to enter the most popular landmarks first. For every Taboo landmark on the map, users receive little, if any points to provide compensation for the user to not attempt to avoid taboo landmarks and to continue playing the game.

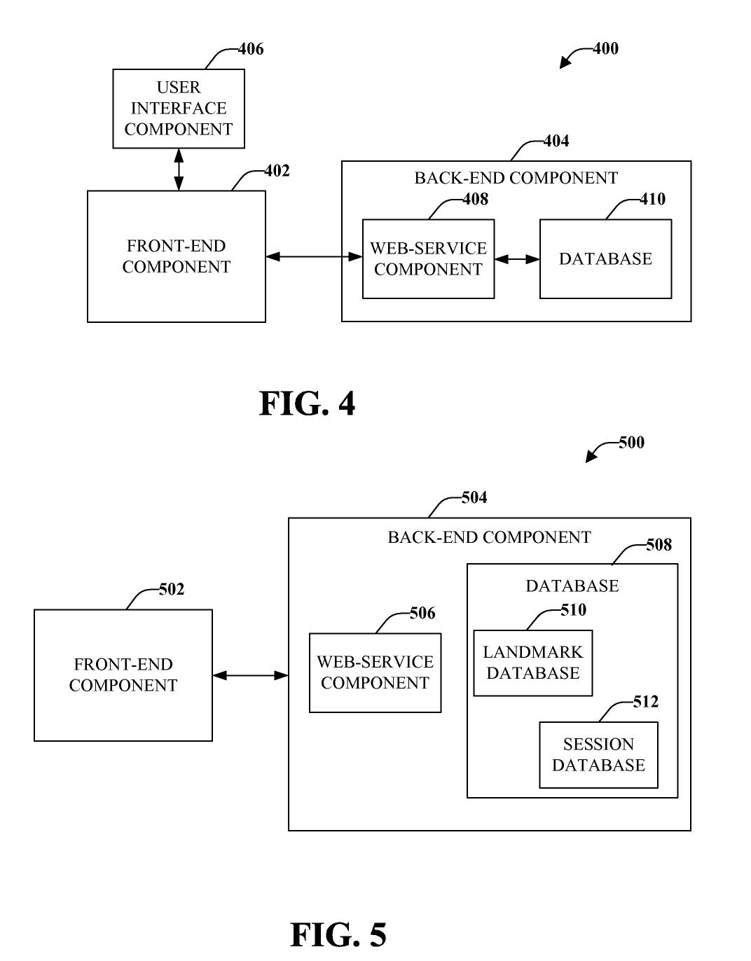

FIG. 4 illustrates a system 400 for providing an interactive location based game. System 400 includes a front-end component 402 that can interact with a game user and a back-end component 404 that interfaces with the front-end component 402 to facilitate various aspects of the interactive game.

The front-end component 402 can include or be associated with a user interface component 406 that can provide a graphical user interface (GUI), a command line interface, a speech interface, Natural Language text interface, and the like. For example, a GUI can be rendered that provides a user with a region or means to input landmark information and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the information conveyance such as vertical and/or horizontal scroll bars for navigation and toolbar buttons to determine whether a region will be viewable can be employed.

The user can also interact with the regions to select and provide information through various devices such as a mouse, a roller ball, a keypad, a keyboard, a pen, gestures captured with a camera, and/or voice activation, for example. Typically, a mechanism such as a push button or the enter key on the keyboard can be employed subsequent to entering the information in order to initiate information conveyance. However, it is to be appreciated that the disclosed embodiments are not so limited. For example, merely highlighting a check box can initiate information conveyance. In another example, a command line interface can be employed. For example, the command line interface can prompt the user for information by providing a text message, producing an audio tone, or the like. The user can then provide suitable information, such as alphanumeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

Back-end component 404 is where the processing on the server and the database occur and can include a web-service component 408 and a database 410. Web-service component 408 can be configured to facilitate the communication with front-end component 402. Web-service component 408 can also be configured to store and retrieve information from database 410.

Various information is tracked by back-end component 404. The information can include user information such as names, credentials and other information (e.g., passwords, scores, location, areas of interest). Back-end component 404 can also track game sessions (both current and previous), maps, guesses entered, and so forth. The game sessions can be associated with the user playing the game.

Each game can be composed of a series of maps that are presented to the player. If a game has a time limit, such as two minutes for example, the player might see seven or more maps, depending on how fast the player inputs answers. Back-end component 404 can track each game session and within each game session all the maps sessions can be maintained. A map can be described by a sense of a spatial coordinate (such as a latitude/longitude pair) and the zoom level or width of the map. Each time a user inputs a landmark name, the name can be retained as well as the result of the guess (e.g., found in the database, how many points awarded and so forth).

FIG. 5 illustrates another system 500 for providing an interactive landmark game. Similar to the above figure, system 500 includes a front-end component 502 and a back-end component 504 that includes a web-service component 506 and a database 508. The database 508 can include a landmark database 510 and a session database 512. The landmark database 510 can include all landmarks known to system 500. This includes the landmarks pre-populated as well as landmarks that players have added. Session database 512 can maintain all the map session and game sessions, which can be associated with a particular user.

The web-service component 506 can be configured to render a new game when the user desires to play a new game. Web-service component 506 can ascertain a region that a user requests and/or determine a region that the user might be familiar with and, thus, can enter meaningful landmarks. Within each game session, the web-service component 506 can present new maps or similar maps having different zoom levels. System 500 should make the game as exciting for the user as possible and, thus, should not display the same map over and over to the same user since the user will quickly lose interest.

Latitude and longitude are two parameters that describe a map. However, other spatial coordinates can be utilized with the disclosed aspects. If a user has played a map before, the user should not be presented with the same latitude/longitude and zoom level if it is a similar map. Otherwise, a random selection in that space of latitude/longitude and zoom level can be chosen for presentation to the player. For example, the space can be bounded by, or has to be within +/−10 miles of the center part that would be of most interest to the user. The zoom levels can also be bounded so that the map area does not include the entire planet or a single city block. Certain areas, such as uninteresting areas, can also be eliminated from view. These include the ocean, desert or other areas with little, if any, landmarks.

Back-end component 504 can be configured to award points. Each time a guess is entered (through interaction with front-end component 504), that guess is sent to web-service component 506 that compares that landmark to landmarks contained in the landmark database 510. Web-service component 506 can also determine whether the landmark is “Taboo”. The landmark would be marked as Taboo if other people have already typed in that landmark and a threshold level of positive confirmation has been achieved or exceeded. Thus, further information relating to that landmark is not necessary. If a landmark is not found in the landmark database 510, the player might not be awarded any points (or minimal points). If the landmark is found but it is taboo, the player might get minimal or no points.

If the landmark is found and it is not Taboo, then the number of points awarded can be a function of the Zoom level. Thus, if the map area is zoomed way out to show the whole United States and the input is the “Statute of Liberty”, the player can be awarded few points because the map is zoomed way out and there are so many landmarks. If zoomed in very tightly (e.g., a few city blocks) the player can receive more points because there might not be many landmarks, or more obscure landmarks in that area.

More points can be awarded for more prominent landmarks rather than for obscure landmarks. The reason for this is that the goal of making the game interesting and harvesting the best landmarks works against each other. If the map area is Seattle, it is desirable to have a large number of players enter “Space Needle” because it will indicate that it is the most prominent landmark in the city. Thus, the more players that agree with the current input, the higher the points awarded.

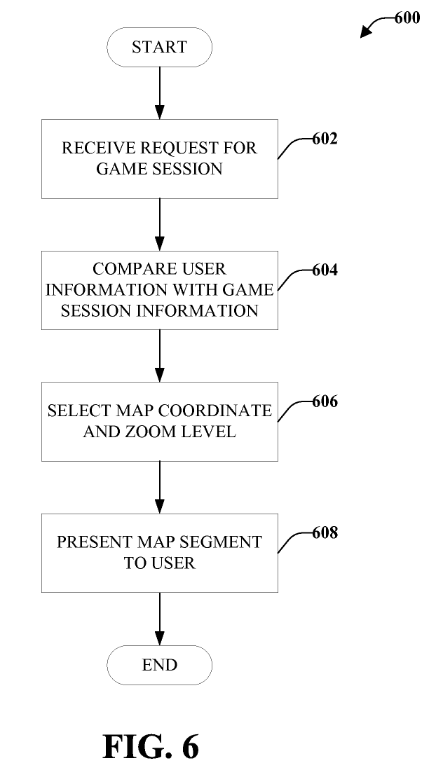

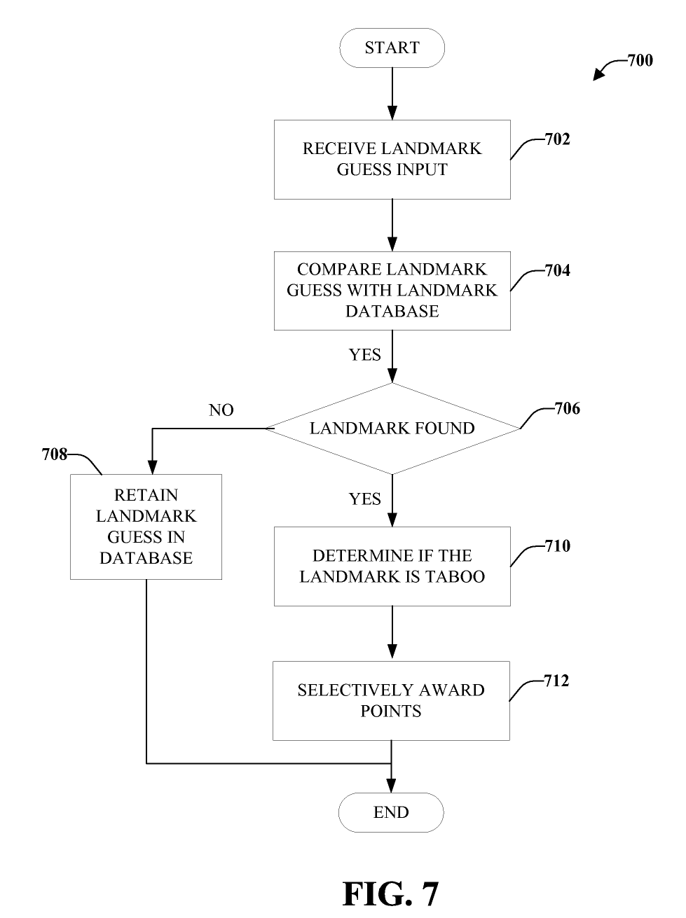

In view of the exemplary systems shown and described above, methodologies that may be implemented in accordance with the disclosed subject matter, will be better appreciated with reference to the flow charts of FIGS. 6 and 7. While, for purposes of simplicity of explanation, the methodologies are shown and described as a series of blocks, it is to be understood and appreciated that the disclosed aspects are not limited by the number or order of blocks, as some blocks may occur in different orders and/or concurrently with other blocks from what is depicted and described herein. Moreover, not all illustrated blocks may be required to implement the methodologies described hereinafter. It is to be appreciated that the functionality associated with the blocks may be implemented by software, hardware, a combination thereof or any other suitable means (e.g. device, system, process, component). Additionally, it should be further appreciated that the methodologies disclosed hereinafter and throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

FIG. 6 illustrates a method 600 for providing an interactive map based landmark game. The game can be played by a single user to test such user's knowledge of a geographic area represented by one or more map segments presented to the user during the game session.

Method 600 starts, at 602, when a game session is requested from a user. The user can enter a userid/password pair, or might provide other identifying information (e.g., email alias). At 604, the user information is compared with game session information, which can be maintained individually or in combination with the user information.

At 606, a map spatial coordinate and zoom level is selected. This selection can be based on the comparison of the user information with the game session information. If a user has viewed and entered information on a map segment, the segment information is maintained so that the user is not presented with substantially the same map, which can provide a richer gaming experience. A map segment is presented to the user, at 608. This segment should be different from previous segments viewed by the user, if any.

FIG. 7 illustrates a method 700 for awarding points as a function of a spatial coordinate and/or zoom level. Method 700 starts, at 702, when a landmark guess is entered. The landmark guess can include a name that a user playing a map based landmark game associates with a particular landmark in a displayed map segment. At 704, the landmark guess is compared with a landmark database. The landmark database can be pre-populated with known landmarks, as well as landmark guesses entered in previous gaming sessions by other users. At 706, a determination is made whether the landmark information is found in the landmark database.

If the landmark is not found (“NO”) method continues, at 708, and the landmark guess is retained in the landmark database. If the landmark is found (“YES)”, at 710, a determination is made whether the landmark is taboo, which indicates that further information relating to the landmark is not necessary.

At 712, points are selectively awarded based on a spatial coordinate and/or a zoom level. Fewer points might be awarded for entered landmarks that are taboo. A higher zoom level (e.g., smaller map segment) can result in more points being awarded for correct landmarks. However, other manners of providing incentives for users to populate a landmark database can be utilized.

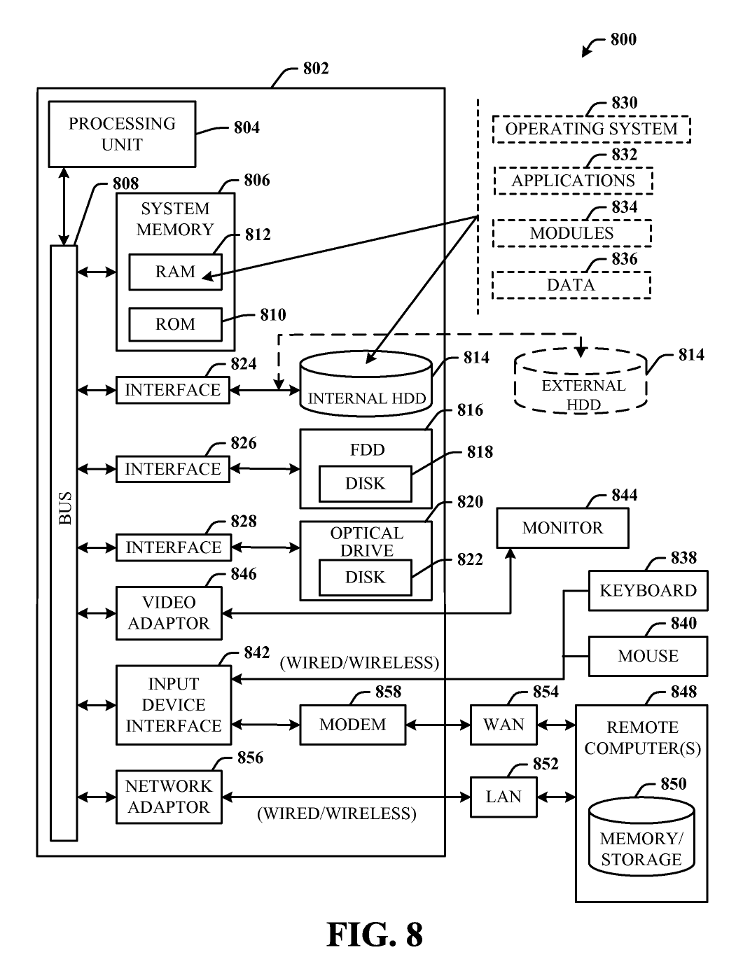

Referring now to FIG. 8, there is illustrated a block diagram of a computer operable to execute the disclosed architecture. In order to provide additional context for various aspects disclosed herein, FIG. 8 and the following discussion are intended to provide a brief, general description of a suitable computing environment 800 in which the various aspects can be implemented. While the one or more aspects have been described above in the general context of computer-executable instructions that may run on one or more computers, those skilled in the art will recognize that the various aspects also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the one or more aspects.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods disclosed herein.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the various aspects can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 through an interface, such as a video adapter 846. In addition to the monitor 844, a computer typically includes other peripheral output devices (not shown), such as speakers, printers, etc.

The computer 802 may operate in a networked environment using logical connections through wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adaptor 856 may facilitate wired or wireless communication to the LAN 852, which may also include a wireless access point disposed thereon for communicating with the wireless adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 through the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from home, in a hotel room, or at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

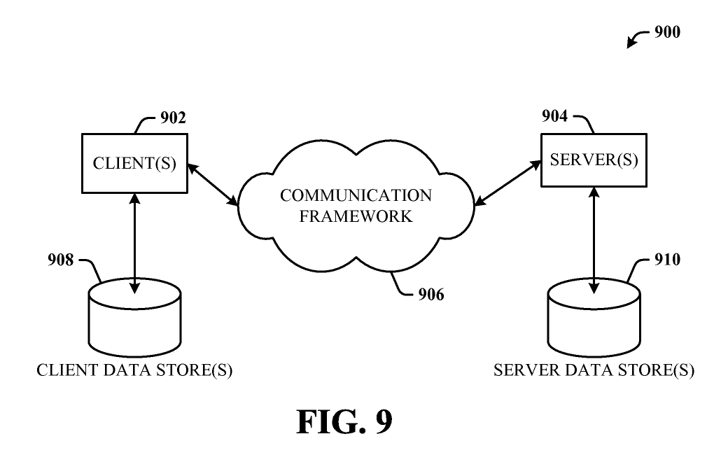

Referring now to FIG. 9, there is illustrated a schematic block diagram of an exemplary computing environment 900 in accordance with the various aspects. The system 900 includes one or more client(s) 902. The client(s) 902 can be hardware and/or software (e.g., threads, processes, computing devices). The client(s) 902 can house cookie(s) and/or associated contextual information by employing the various aspects, for example.

The system 900 also includes one or more server(s) 904. The server(s) 904 can also be hardware and/or software (e.g., threads, processes, computing devices). The servers 904 can house threads to perform transformations by employing the various aspects, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated through a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

What has been described above includes examples of the various aspects. It is, of course, not possible to describe every conceivable combination of components or methodologies for purposes of describing the various aspects, but one of ordinary skill in the art may recognize that many further combinations and permutations are possible. Accordingly, the subject specification intended to embrace all such alterations, modifications, and variations.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects. In this regard, it will also be recognized that the various aspects include a system as well as a computer-readable medium having computer-executable instructions for performing the acts and/or events of the various methods.

In addition, while a particular feature may have been disclosed with respect to only one of several implementations, such feature may be combined with one or more other features of the other implementations as may be desired and advantageous for any given or particular application. To the extent that the terms “includes,” and “including” and variants thereof are used in either the detailed description or the claims, these terms are intended to be inclusive in a manner similar to the term “comprising.” The term “or” as used in either the detailed description of the claims is meant to be a “non-exclusive or”.

The word “exemplary” as used herein to mean serving as an example, instance, or illustration. Any aspect or design described herein as “exemplary” is not necessarily to be construed as preferred or advantageous over other aspects or designs.

Furthermore, the one or more aspects may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

What is claimed is:

1. A system that facilitates a map-based landmark identification game, comprising:
a front-end component that provides a user with a map segment and a text entry area for entry of a landmark name; and
a back-end component that compares the landmark name with a landmark database and selectively awards points based on the comparison.

2. The system of claim 1, further comprising a web-service component that facilitates communication between the front-end component and a database.

3. The system of claim 1, the back-end component further tracks current and previous game sessions associated with a current player and suggests a map segment that is different from previous game sessions.

4. The system of claim 3, the map segment is different from a previous game session as a function of a spatial coordinate, a zoom level, or combinations thereof.

5. The system of claim 1, the back-end components awards more points for commonly-known landmarks as compared to obscure landmarks.

6. The system of claim 1, further comprising a web-service component that flags a location as taboo when a counter meets or exceeds a threshold level.

7. The system of claim 6, meeting or exceeding a threshold level confirms a landmark name and the web-service component assigns a familiarity value to the landmark.

8. The system of claim 6, the back-end component awards minimal points for the landmark flagged as taboo.

9. The system of claim 1, the front-end component provides a text box in which a user can enter the landmark name by clicking a location on the map segment.

10. The system of claim 1, is a game played by a single user.

11. A method for populating a map with landmark-based descriptions, comprising:
rendering a geographic area on a display;
receiving a landmark location within the geographic area and a text label associated with the landmark; and
selectively correlating the landmark location and the text label with the geographic area.

12. The method of claim 11, selectively correlating the landmark location and the text label with the geographic area, comprising:
determining if a landmark with a similar text label was previously received; and
incrementing a counter associated with the landmark if a similar text label was previously received for that landmark.

13. The method of claim 12, further comprising:
determining if the counter has met or exceeded a threshold level;
confirming a landmark name if the threshold level has been met or exceeded; and
assigning a familiarity value to the landmark.

14. The method of claim 12, further comprising:
determining if the counter has met or exceeded a threshold level;
flagging a landmark as taboo when a counter meets or exceeds a threshold level; and
awarding minimal points for the landmark flagged as taboo.

15. The method of claim 11, selectively correlating the landmark location and the text label with the geographic area, comprising:
determining if a landmark with a similar text label was previously received;
presenting a menu with a closely located landmark if a similar text label was not previously received;
soliciting feedback whether the closely located landmark is the received landmark location; and
selectively updating a text label associated with the closely located landmark if the received landmark is the received landmark location.

16. The method of claim 11, further comprising selectively awarding points based in part on the correlation between the landmark location and the text label.

17. The method of claim 14, further comprising awarding more points for commonly-known landmarks as compared to obscure landmarks.

18. The method of claim 11, rendering a geographic area on a display comprises choosing a different geographic area as a function of a spatial coordinate, a zoom level, or combinations thereof.

19. A computer executable system that provides a mapped based interactive game, comprising:
means for providing a user with a map segment and a text entry area for entry of a landmark name; and
means for comparing the landmark name with a landmark database and selectively awarding points based on the comparison.

20. The system of claim 19, further comprising:
means for tracking current and previous game sessions associated with a current player; and
means for suggesting a map segment that is different from previous game sessions as a function of a spatial coordinate, a zoom level or combinations thereof.
